(19) United States
(12) Patent Application Publication
(10) Pub. No.: US 2019/0154540 A1
(43) Pub. Date: May 23, 2019

(54) METHOD AND DEVICE FOR LOCATING A LEAK ON AT LEAST ONE LIQUID LINE

(71) Applicant: Grohe AG, Hemer (DE)

(72) Inventor: Bert DEPIERE, Wakkerzeel (BE)

(73) Assignee: Grohe AG, Hemer (DE)

(21) Appl. No.: 16/199,038

(22) Filed: Nov. 23, 2018

(30) Foreign Application Priority Data
Nov. 23, 2017 (DE) 102017127693.9

(51) Int. Cl. G01M 3/28

(52) U.S. Cl. CPC G01M 3/2815

(57) ABSTRACT

A method of locating a leak on at least one liquid line having at least the following steps: closing the at least one liquid line with a first valve; opening a second valve so that a signal gas flows from a signal gas source via the second valve into the at least one liquid line, and from the at least one liquid line out of the leak. A device for locating a leak on at least one liquid line is also provided.

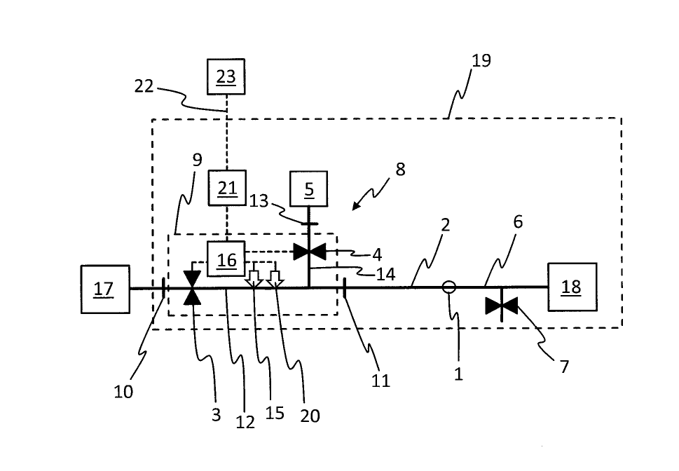

This nonprovisional application claims priority under 35 U.S.C. § 119(a) to German Patent Application No. 10 2017 127 693.9, which was filed in Germany on Nov. 23, 2017, and which is herein incorporated by reference.

### BACKGROUND OF THE INVENTION

### Field of the Invention

The present invention relates to a method and a device for locating a leak on at least one liquid line. The invention serves in particular to prevent water damage due to escaping liquids.

### Description of the Background Art

In buildings, a variety of water pipes is regularly laid, which are routed from a liquid source, such as a public water supply network, to various consumer loads, such as sanitary appliances, dishwashers or washing machines. Leaks can occur on these liquid lines, for example, in the form of burst pipes or cracks through which liquid can escape. The exiting liquid can cause major damage to the building, masonry and/or building facilities at the exit points.

For this reason, a variety of methods for detecting leaks in liquid lines is already known. For example, large liquid leaks, as they occur for example in pipe breaks, can be detected by means of flow sensors.

Minor leaks, such as drip leaks, can be detected with methods in which, for example, a pressure drop within a predetermined test period is measured in the liquid lines. With this method, however, it is only possible to detect whether there is a leak, but not where the leak is located on the liquid line. The search to locate the leaks is therefore often time-consuming and expensive.

### SUMMARY OF THE INVENTION

It is therefore an object of the invention to solve the problems described with reference to the prior art and in particular, to provide a method for locating a leak on at least one liquid line, with which the location of the leak can be determined on the at least one liquid line. In addition, a device for locating a leak on at least one liquid line is to be specified, with which the location of the leak on the at least one liquid line can be easily determined.

These objects are achieved with a method and a device according to the invention and it is be noted that the features listed can be combined in any technologically meaningful manner and can define further embodiments of the invention.

The inventive method for locating a leak on at least one liquid line comprises at least the following steps: closing the at least one liquid line with a first valve; and opening a second valve, so that a signal gas flows from a signal gas source via the second valve into the at least one liquid line, and from the at least one liquid line out of the leak.

The method is used to locate a leak on at least one liquid line, which is routed in particular at least partially from a liquid source, such as a public water supply network, to at least one consumer load, such as a sanitary appliance, a dishwasher or a washing machine through a unit of consumption, such as a building, an apartment or a hotel room. The at least one liquid line in particular is formed at least partially of metal, such as copper or a copper alloy. The liquid line also has in particular a diameter of 10 mm (millimeters) to 30 mm.

To locate a leak on the at least one liquid line, the at least one liquid line is closed with a first valve. The first valve is in particular an electrically operable valve, for example in the manner of a solenoid valve. In this way, the at least one consumer of the liquid, which may be in particular water, is separated from the liquid source.

A second valve is then opened so that a signal gas flows from a signal gas source via the second valve into the at least one liquid line, and from the at least one liquid line out of the leak. The second valve may also in particular be an electrically operable valve, for example in the manner of a solenoid valve. The second valve is in particular arranged on a signal gas line, which leads from the signal gas source into the at least one liquid line. The signal gas may be a gas that is well recognizable in particular without aids, for example as a result of its color and/or its odor. In addition, the signal gas may in particular be an aerosol, such as a flue gas. In addition, the signal gas is in particular not toxic. The signal gas source can be releasably connected, for example via a connection, in particular a screwed connection, with the at least one liquid line. In this way, the signal gas source can be exchanged if the signal gas stored in the signal gas source, for example, is insufficient or the signal gas source is to be refilled. The signal gas source may be, for example, a pressure vessel and/or a cartridge. Furthermore, the signal gas source may have a signal gas storage space with a volume of, for example, 1 l (liters) to 10 l. The signal gas can be stored in the signal gas source, for example, with a pressure of 2 bar to 10 bar.

After opening the second valve, the signal gas flows from the signal gas source via the second valve into the at least one liquid line, where the signal gas displaces the liquid possibly present in the at least one liquid line and then exits out of the leak. Due to the good recognizability of the signal gas, the location of the leak on the at least one liquid line can be easily detected.

In addition, a pressure chamber can be formed in the at least one liquid line, and a pressure can be measured in the pressure chamber. The formation of the pressure chamber takes place by closing the at least one liquid line with the first valve. The pressure chamber extends in particular from the closed valve to the (closed) at least one consumer load. By measuring the pressure of the liquid, a pressure drop can be determined in the pressure chamber of the liquid line. This is done by measuring the pressure in the pressure chamber over a predetermined measurement period, wherein the pressure drop is the fall of pressure during said measurement period. The measurement of the pressure takes place in particular with a pressure sensor which is arranged on the liquid line and/or in the pressure chamber of the liquid line. If the pressure drop exceeds an agreed limit, it can be concluded that there is a leak and the method can be continued with step b). For evaluating the pressure drop, the pressure sensor may be connected to a controller so as to transfer data. Furthermore, the controller can be connected to the first valve and the second valve so as to transfer data, so that the first valve and the second valve can be actuated by the controller. The controller can comprise at least one microcontroller.

In the event of leak, in particular, an alarm signal can be issued, by which a user or a resident of the building is informed about the leak. The alarm signal can be sent, for example, via wired or wireless connection to a network router, which forwards the alarm signal via internet connection to a (server-based) cloud configuration. The cloud configuration can inform the user or resident of the leak, for example, by means of a push notification to a smartphone. In this way, the user can, for example, initiate the proposed method via an app.

Further, the second valve can be opened as soon as the pressure in the pressure chamber falls below a limit value.

The second valve can be opened as soon as the pressure in the pressure chamber falls below the pressure in the signal gas source.

Moreover, the at least one liquid line can be emptied via a third valve. This means in particular that the liquid from the at least one liquid line is drained. For this purpose, the third valve can in particular be arranged at a lowermost point or a depression of the at least one liquid line in the consumption unit. The drained liquid may, for example, be discharged into a sewer system.

Furthermore, the signal gas can be heated. The heating can be done, for example, to a temperature of about 50° C. (Celsius). For this purpose, a signal gas heater for the signal gas may be arranged on the signal gas source, the signal gas line and/or the at least one liquid line.

In addition, the at least one liquid line can be cleaned. This step can be carried after the above described prior step. The cleaning can be done, for example, by flushing the at least one liquid line with the liquid, for which purpose the first valve and preferably all consumer loads are opened. Cleaning can ensure that there are no signal gas or signal gas residues left in the at least one liquid line. The successful cleaning of the at least one liquid line can be relayed to the user, for example, optically, acoustically and/or by a push notification.

According to a further aspect of the invention, a device for locating a leak on at least one liquid line is proposed, comprising at least the following components: a housing having a liquid inlet and a liquid outlet; a liquid channel, which runs from the liquid inlet through the housing to the liquid outlet; a first valve with which the liquid channel can be closed; and a connection for a signal gas source, wherein a signal gas can be supplied via the connection from the signal gas source to the liquid channel.

The device may be, for example, a water meter by means of which, for example, the annual consumption of the liquid can be tracked. The device comprises a housing, which may for example be formed at least partially of plastic and/or metal. The at least one liquid line can be connected to the liquid inlet and the liquid outlet, for example, via a screwed connection, so that the liquid may flow from the liquid inlet through a liquid channel of the housing, through the housing to the liquid outlet. The device is thus connected to the at least one liquid line in a fixed and/or in particular permanent manner. The liquid channel and thus the at least one liquid line can be closed with the first valve. In addition, the housing has a connection for a signal gas source to which the signal gas source can also be attached, for example, via a screwed connection. The signal gas can be supplied from the connection, in particular via a signal gas line which in particular at least partially extends through the housing, to the liquid channel and thus to the at least one liquid line.

In addition, the device may have a third valve, by means of which a signal gas line between the signal gas source and the liquid line can be closed. The third valve may in particular also be an electrically operable valve, for example in the manner of a solenoid valve. Further, the third valve may also be data-conductively connected with the controller so that the third valve can also be actuated by the controller.

Furthermore, the device may comprise a pressure sensor, by means of which the pressure in the liquid channel can be measured. With respect to further details of the device, reference is made to the description of the method.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein the sole FIGURE illustrates a consumption unit with a device.

### DETAILED DESCRIPTION

The sole FIGURE schematically shows a consumption unit 19 with a device 8. The consumption unit 19 here is a building. The device 8 comprises a housing 9 with a liquid inlet 10 and a liquid outlet 11. A liquid line 2 is connected to the liquid inlet 10 and the liquid outlet 11, so that a liquid can be routed from a liquid source 17 to a liquid consumer load 18 via the liquid line 2 and a liquid channel 12 of the device 8. The amount of liquid flowing through the liquid channel 12 and the liquid line 2 can be measured by means of a flow sensor 20 of the device 8, which is data-conductively connected to a controller 16 of the device 8. The device 8 further comprises a first valve 3, which can be actuated by the controller 16 and by means of which the liquid channel 12 and thus the liquid line 2 can be closed. By closing the first valve 3, a pressure chamber 6 can be formed in the liquid channel 12 and the liquid line 2, between the first valve 3 and the consumer load 18. The pressure of the liquid in the pressure chamber 6 can also be measured with a pressure sensor 15 of the device 8, which is also data-conductively connected to the controller 16. By evaluating the measured pressure in the pressure chamber 6, a leak can be detected by the controller 16. In detecting a leak, the controller 16 opens a second valve 4 in a signal gas line 14, so that a signal gas flows from a signal gas source 5, which is connected to the device 8 via a connection 13, into the liquid channel 12 and the liquid line 2 via the signal gas line 14. At the same time, the controller 16 opens a third valve 3, so that the liquid present in the pressure chamber 6 can drain. Here, the controller 16 is connected with the third valve 7 via a radio link. The signal gas passes through the liquid channel 12 and the liquid line 2 to a leak 1 on the liquid line 2 and exits out of the leak 1, so that the location of the leak 1 can be identified. The controller may also be data- conductively connected to a cloud configuration 23 outside the consumption units 19 via a network router 21 and an internet connection 22.

By means of the present invention, the location of a leak can be identified particularly easily.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for locating a leak on at least one liquid line, the method comprising:
a) closing the at least one liquid line with a first valve; and
b) opening a second valve so that a signal gas flows from a signal gas source via the second valve into the at least one liquid line, and from the at least one liquid line out of the leak.

2. The method according to claim 1, wherein in step (a), a pressure chamber is formed in the at least one liquid line and a pressure is measured in the pressure chamber.

3. The method according to claim 2, wherein in step b), the second valve is opened as soon as the pressure in the pressure chamber falls below a limit value.

4. The method according to claim 2, wherein in step b), the second valve is opened as soon as the pressure in the pressure chamber drops below the pressure in the signal gas source.

5. The method according to claim 1, wherein the at least one liquid line is emptied via a third valve.

6. The method according to claim 1, wherein the signal gas is heated.

7. The method according to claim 1, wherein in a step c), the at least one liquid line is cleaned.

8. A device for locating a leak on at least one liquid line, the device comprising:
a housing having a liquid inlet and a liquid outlet;
a liquid channel leading from the liquid inlet through the housing to the liquid outlet;
a first valve with which the liquid channel is adapted to be closed; and
a connection for a signal gas source, wherein a signal gas is suppliable from the signal source to the liquid channel via the connection.

9. The device according to claim 8, further comprising a third valve via which the signal gas line between the signal gas source and the liquid line is adapted to be closed.

10. The device according to claim 8, further comprising a pressure sensor via which the pressure in the liquid channel is adapted to be measured.
